(19) United States
(12) Patent Application Publication
(10) Pub. No.: US 2025/0086579 A1
(43) Pub. Date: Mar. 13, 2025

(54) Inventory by Cambridge

(71) Applicant: Dishana Cambridge, Charlotte, NC (US)

(72) Inventor: Dishana Cambridge, Charlotte, NC (US)

(21) Appl. No.: 18/244,325

(22) Filed: Sep. 11, 2023

(51) Int. Cl. G06Q 10/087

(52) U.S. Cl. CPC G06Q 10/087

(57) ABSTRACT

This disclosure generally relates to a systematic method for inventory management wherein the user can manage the storage location, can track inventory stocks, expiry dates, level of stocks, and other features through a dashboard. The system is easy to use and provides reliable output.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

This invention relates generally to systems and methods for managing an inventory and, more particularly, to systems and methods for tracking and managing an inventory of various products.

### Description of the Related Art

Prior inventory management systems and methods involved a large number of manually conducted tasks. These systems were labor intensive. Also, the manual steps often led to errors in the system's results. These methods provided inaccurate measurements and throughout the processes, time delays are common and inevitable. Also, the material in the silo is being used and the amount is not known. Using these methods an accurate, real-time inventory level is not achieved.

The determined amount, which in most instances is not the real-time exact amount due to time delays, is reported to a purchasing agent. The purchasing agent determines if an order should be placed and when it should be placed. The purchasing agent then contacts a vendor to determine if the vendor has inventory available. If some inventory is available from that vendor, the purchasing agent then places an order that will be filled in due course. The order is placed probably without regard to current market costs, transportation costs, and other peripheral costs, since the inventory is needed to maintain the manufacturing site operation. If the vendor does not have that inventory, the purchasing agent must find a vendor who has that inventory in stock, and may buy from the first vendor with available inventory, again regardless of cost.

By looking at prior art various advances have been system. However, a system, provides real-time inventory management of supply at a site, including specifying sublocations and categories. It also allows users to track the quantity of inventory and check expired dates and the QR/UPC scanner will allow them to check information on the products.

Thus it has been noted, to Applicant's knowledge, none of these prior art methods is entirely suitable to meet these needs and is cumbersome. Therefore, there is a need in the prior art in which the inconveniences, as mentioned earlier, difficulties, and grooming problems are eliminated for all practical purposes. Thus, the present invention provides such a method, which will solve problems by organizing your life and items in the inventory, saving money by not purchasing items that you already have in the inventory, and also by saving packaging materials by avoiding additional unnecessary items. The overall combination of these features is nowhere disclosed in the prior art cited above, which appears to represent the general art in this area, although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a complete description. A full appreciation of the various aspects of the invention can be gained by taking the entire specification, claims, drawings, and abstract as a whole.

Methods, systems, and articles of manufacture consistent with certain aspects related to the present invention provide a process for managing an inventory of items, each item being positioned in a respective location within an environment

Another objective of the invention is the step of providing a setup unit, a tracking unit and a reporting unit. Preferably, the system has a database for storing data and is an interactive system accessible via the Internet. In addition, the system is used preferably in conjunction with a data collection device capable of scanning and storing UPC bar codes, and transferring data to and receiving data from the main system.

It is also the objective of the system allowing at least one storage receptacle that stores inventory; at least one amount indicator that determines an inventory amount in each receptacle, each amount indicator generating inventory amount signals representative of inventory amounts in the receptacle; at least one inventory price source that provides inventory price information; and a control unit that receives the inventory amount signals from the amount indicator and inventory price information from the inventory price source. The control unit analyzes the inventory amount signals to determine amounts in the receptacle. The control unit also analyzes the amounts and inventory price information, and uses this information to determine if an inventory order should be placed.

It is accordingly an object of the invention to provide a dedicated application wherein the inventory management process may include at least one of an out-of-stock control process, a shrinkage recognition process, a rapid product recall process, an alert monitor process, and a sales optimization process. Each of these processes may perform various tasks that are used to manage the inventory of items in the environment, such as monitoring inventory levels of the items, detecting misplaced items in the environment, and providing feedback information associated with the items based on detected events (e.g., suggested alternative locations for certain items based on sales data).

Although the invention is illustrated and described herein as embodied in as a online feedback system which is accessible through web and computer client application, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Other objects, features and advantages of the present invention will be apparent from the accompanying drawing and from the detailed description which follows.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention now will be described more fully hereinafter. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Inventory management is becoming increasingly important in today's growing economy. New products are continuously being developed and placed in the market for consumer purchase. Although this growth provides consumers with more choices for selecting various goods and services, businesses (e.g., retailers, wholesalers, etc.) are tasked with managing this growing inventory.

The present disclosure is directed to business methods for providing inventory management process. Systems and methods consistent with certain aspects related to the present invention enable an intelligent inventory management process to monitor and collect information associated with an inventory of items (e.g., products) included in an environment. An item, as the term is used herein, may be any type of product that is manufactured, developed, grown by a farm business, and provided by a manufacturer, business entity, individual, group of individuals, etc. For example, an item may be food (e.g., produce, dairy products, canned goods, etc.), an article of clothing, a plant or similar type of horticultural product, a machined part for an engine, sporting goods, etc. Further, an item may be associated with live animals or fish, such as livestock (e.g., cattle) that are raised by a livestock provider and sold to a livestock processing business. Alternatively, an item may be a domesticated or non-domesticated animal, such as a dog or reptile that is raised and/or maintained by an animal provider or caretaker (e.g., pet store, zoo, etc.).

The collected information may be used to perform various inventory management processes that enable a user to control the inventory of items, monitor shrinkage, facilitate and identify recalled or defective items included in the inventory, manage the misplacement of items within the environment, and receive alert messages associated with a variety of items inventory conditions, such as expiry conditions, out of stock conditions, etc.

Environments may each represent an environment associated with a business or non-business entity. In one aspect of the invention, each environment may include, or is associated with, physical structures that manufacture, produce, maintain, store, and/or sell items. For example, environments may represent a retail store that sells items, a warehouse that purchases, stores, maintains, and/or ships items, a stock room that stores supplies, home or various types of vehicles etc. Environments may also represent a main office business entity that manages the sale, production, storage, etc., of items located and sold in other environments. For instance, several environments may represent a retail outlet store, such as a supermarket, that sells items directly to consumers (i.e., users) and the environment may represent a main office that manages the inventory and other business aspects of each of the several environments. In accordance with certain aspects of the present invention, one or more environments may perform intelligent inventory management based on item information collected by automated services performed within the environment(s).

To perform the intelligent inventory management services consistent with aspects related to the present invention, each environment may include an Intelligent Inventory Management System (IIMS), a Data Collection System (DCS), and item inventory. IIMS may represent one or more computing systems, such as a server, personal computer, workstation, laptop, or any other similar computer system known in the art, that performs one or more processes consistent with certain aspects of the present invention.

It is appreciated that additional advantages, modifications and equivalent embodiments will be apparent to those skilled in the art. Therefore, the invention, in its broader aspects, is not limited to the specific details shown and described herein. Accordingly, various modifications may be made without departing from the spirit or scope of this invention as defined by the appended claims and their equivalents.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The invention claimed is:

1. A processor-based inventory data collection computer for efficiently collecting and validating inventory data, comprising:
a central processor coupled to a system bus, the central processor adapted to receive the inventory data and operable to validate the inventory data using a plurality of program codes;
at least one flash memory coupled to the system bus, the flash memory adapted to store inventory data as the data is entered into the device and also adapted to store the program code;
at least one random access memory coupled to the system bus, the random access memory adapted to store validation tables and validated inventory data, the validation tables used by the central processor to validate the inventory data;
a scanner interface adapted to couple an external scanner to the central processor and operable to transfer the inventory data to the central processor from the external scanner;
a keyboard for entering the inventory data into the computer;
a display operable to show a report of the inventory data collection;

2. The inventory data collection system of claim 1, wherein the system may specify the location and categories.

3. The inventory data collection system of claim 1, wherein the user can track the quantity and expiry dates of stock.

4. The inventory data collection system of claim 1, wherein a QR/UPC scanner is used to check the quantity and expiry dates of stock.

5. The inventory data collection system of claim 1, wherein the system will generate alerts in case of low stock.

6. The inventory data collection system of claim 1, wherein the system will allow t navigate through all items present in the stock.

7. The inventory data collection system of claim 1, wherein the system will also allow to store items using location and sub-location.
